(19) United States
(12) Patent Application Publication
(10) Pub. No.: US 2024/0077982 A1
(43) Pub. Date: Mar. 7, 2024

(54) NON-TRANSITORY COMPUTER-READABLE STORAGE MEDIUM STORING A PROGRAM, METHOD FOR CONTROLLING INFORMATION PROCESSING APPARATUS, INFORMATION PROCESSING APPARATUS, AND IMAGE PROCESSING APPARATUS

(71) Applicant: CANON KABUSHIKI KAISHA, Tokyo (JP)

(72) Inventor: SATOKI WATARIUCHI, Tokyo (JP)

(21) Appl. No.: 18/459,656

(22) Filed: Sep. 1, 2023

(30) Foreign Application Priority Data
Sep. 5, 2022 (JP) 2022-140521

(51) Int. Cl. G06F 3/04812

(52) U.S. Cl. CPC G06F 3/04812

(57) ABSTRACT

An application that is executed by a data processing apparatus serving as a mobile terminal and transmits a performance instruction (job performance request) to perform a job to an image forming apparatus displays a user interface (a stop button, a notification of a notification center) for receiving a stop operation of transmitting, to the image forming apparatus, a stop instruction (job stop request) to instruct the image forming apparatus to stop performing the job based on the performance instruction, regardless of a screen for the performance instruction by the application and a screen after the performance instruction.

### BACKGROUND

### Field of the Disclosure

The present disclosure relates to a non-transitory computer-readable storage medium storing a program and a method for controlling an information processing apparatus.

### Description of the Related Art

In recent years, high-performance mobile terminals called smartphones are increasingly used, and applications that enable use of an image forming apparatus (also referred to as “image processing apparatus”) from a mobile terminal are provided. For example, Japanese Patent No. 6226807 proposes a technique for making job settings of a function (copy, scan, fax) of an image forming apparatus using a mobile terminal and transmitting the job settings to the image forming apparatus, thus enabling the image forming apparatus to perform a job. Use of the technique makes it possible to start the job of the image forming apparatus from the mobile terminal.

Typical techniques have an issue of operability in stopping job performance that has been started using a mobile terminal. Cases where a job needs to be stopped are often urgent cases. For example, a user may notice that a transmission destination is wrong during scanning or that an intended printed material is not output during printing. In such cases, the job is demanded to be stopped as soon as possible.

With the technique discussed in Japanese Patent No. 6226807, however, the mobile terminal after transmitting the job settings no longer communicates with the image forming apparatus. Thus, in order to stop the job being performed, the user needs to operate an operation unit of a main body of the image forming apparatus. The user using the mobile terminal to perform the job may be unfamiliar with the operation of the main body of the image forming apparatus or may wish to avoid touching the main body of the image forming apparatus that is often touched by a number of persons. In such cases, the user may be perplexed or may hesitate in operating the main body of the image forming apparatus, and consequently, the job being performed may not be stopped promptly.

Performing communication of the mobile terminal after transmitting the job settings communicates with the image forming apparatus and displaying of a job performance status on a screen of the mobile terminal presumably enable the job to be stopped using the screen. With this method, however, the screen of the mobile terminal is occupied until the job ends, and this lowers usability. Once the screen of the mobile terminal on which the job performance status is displayed is closed, it is no longer possible to stop the job from the mobile terminal. In this case, in order to stop the job, the user needs to operate the main body of the image forming apparatus.

### SUMMARY

The present disclosure is directed to providing a method for improving usability by facilitating issuance of an instruction to stop a job started using an information processing apparatus.

According to an aspect of the present disclosure, a non-transitory computer-readable storage medium storing a program for executing a method for controlling an information processing apparatus capable of communicating with an image processing apparatus. The method includes performing control to transmit, to the image processing apparatus, a performance instruction to perform a job, and performing control to display, regardless of a screen shift in an application program for receiving the performance instruction, a specific display item configured to receive a stop operation for transmitting, to the image processing apparatus, a stop instruction to instruct the image processing apparatus to stop performing the job based on the performance instruction, the program included in the application program.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a data processing system according to one or more aspects of the present disclosure.

FIG. 2 is a block diagram illustrating a hardware configuration of a data processing apparatus according to one or more aspects of the present disclosure.

FIG. 3 is a block diagram illustrating a hardware configuration of an image forming apparatus according to one or more aspects of the present disclosure.

FIG. 4 is a block diagram illustrating a software configuration of the data processing apparatus according to one or more aspects of the present disclosure.

FIG. 5 is a block diagram illustrating a software configuration of the image forming apparatus.

FIG. 6 is a sequence diagram illustrating communication between the data processing apparatus and the image forming apparatus according to one or more aspects of the present disclosure.

FIG. 7 is a flowchart illustrating a job performance instruction process that the data processing apparatus performs according to one or more aspects of the present disclosure.

FIG. 8 is a flowchart illustrating an example of a job stop instruction process that the data processing apparatus performs according to one or more aspects of the present disclosure.

FIGS. 9A to 9E are diagrams each illustrating a screen of the data processing apparatus according to one or more aspects of the present disclosure one or more aspects of the present disclosure.

FIG. 10 is a flowchart illustrating a process that the image forming apparatus performs according to one or more aspects of the present disclosure.

FIG. 11 is a flowchart illustrating a job performance instruction process that the data processing apparatus performs according to one or more aspects of the present disclosure.

FIG. 12 is a flowchart illustrating an example of a job stop instruction process that the data processing apparatus performs according to one or more aspects of the present disclosure.

FIGS. 13A and 13B are diagrams each illustrating a screen of the data processing apparatus according to the second exemplary embodiment.

### DESCRIPTION OF THE EMBODIMENTS

Various exemplary embodiments of the present disclosure will be described in detail below with reference to the accompanying drawings. It is to be noted that components according to the exemplary embodiments are mere examples and are not intended to limit the scope of the present disclosure.

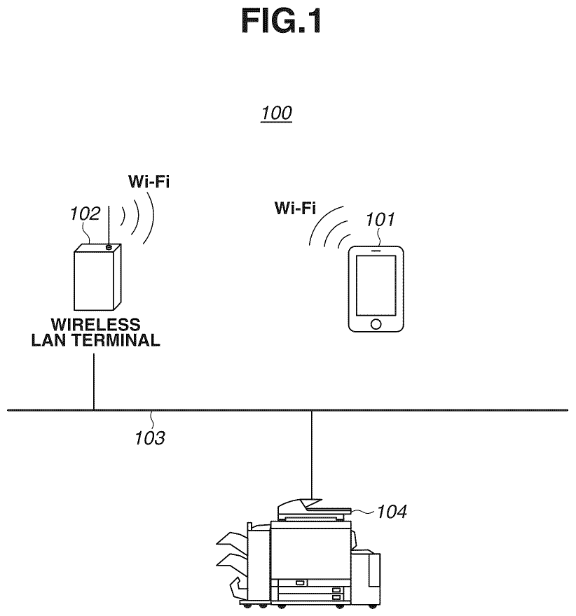

A first exemplary embodiment of the present disclosure will be described below. FIG. 1 is a diagram illustrating an example of a configuration of a data processing system according to the first exemplary embodiment of the present disclosure.

A data processing system 100 includes a data processing apparatus 101, a wireless local area network (wireless LAN) terminal 102, and an image forming apparatus 104. The data processing apparatus 101, the wireless LAN terminal 102, and the image forming apparatus 104 are connected together via a network 103 to communicate with each other.

The data processing apparatus 101 is an information processing apparatus capable of communicating with the image forming apparatus 104 and is a client terminal from which a user can operate the image forming apparatus 104. While a mobile terminal, such as a smartphone, will be described below as an example in the present exemplary embodiment, the data processing apparatus 101 may be a personal computer (PC). The data processing apparatus 101 is connected to the network 103 via the wireless LAN terminal 102.

The wireless LAN terminal 102 is a wireless LAN parent device with a general network router function and provides a wireless LAN via Wi-Fi® in a house or an office.

The image forming apparatus 104 is an image processing apparatus referred to as a digital multi-function peripheral including various job performance functions, such as printer, copy, scanner, and fax transmission functions. The user can issue job performance instructions to the image forming apparatus 104 to perform various functions of the image forming apparatus 104 by operating the data processing apparatus 101.

Furthermore, the data processing apparatus 101 and the image forming apparatus 104 are capable of performing short-range wireless communication via near-field communication (NFC) or Bluetooth® Low Energy wireless signals.

The data processing system 100 is a system in which the data processing apparatus 101 and the image forming apparatus 104, as described above, cooperate together to perform jobs.

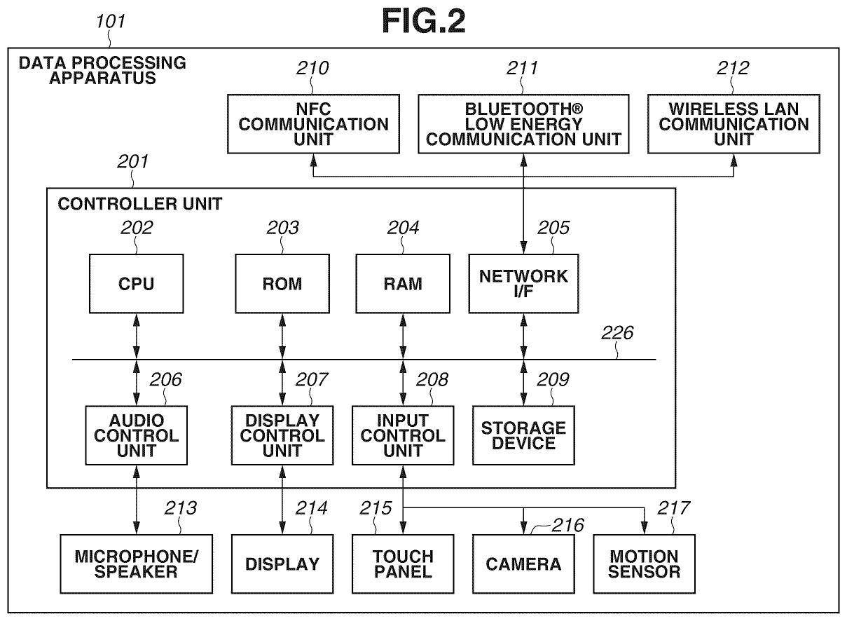

FIG. 2 is a block diagram illustrating an example of a hardware configuration of the data processing apparatus 101 according to the present exemplary embodiment.

The data processing apparatus 101 includes a controller unit 201. The controller unit 201 controls various communication units, such as a NFC communication unit 210, a Bluetooth® Low Energy communication unit 211, and a wireless LAN communication unit 212, various user interface (UI) units, such as a microphone speaker 213, a display 214, and a touch panel 215, a camera 216, and a motion sensor 217. The motion sensor 217 performs a detection function of detecting at least one of a tilt and a shake of the data processing apparatus 101.

The controller unit 201 includes a central processing unit (CPU) 202, a read-only memory (ROM) 203, a random access memory (RAM) 204, a network interface (network I/F) 205, an audio control unit 206, a display control unit 207, an input control unit 208, and a storage device 209, all of which are connected via a system bus 226.

The CPU 202 controls an entire system of the data processing apparatus 101.

The ROM 203 stores an operating system (OS) of the data processing apparatus 101 and application programs for controlling calls and data communication, and the CPU 202 executes various programs. Hereinafter, each application program will be referred to as “application”.

The RAM 204 is a memory for use by the CPU 202 in executing various programs and is a work memory area for use by the applications in executing the programs.

The storage device 209 is a non-volatile storage apparatus and records operation logs and various operation mode settings to be retained even after the data processing apparatus 101 is re-activated. The storage device 209 may store programs.

The network OF 205 is connected to the NFC communication unit 210, the Bluetooth® Low Energy communication unit 211, and the wireless LAN communication unit 212 and controls various types of wireless communications with the image forming apparatus 104.

The audio control unit 206 controls audio data input and output via the microphone speaker 213. The display control unit 207 controls output of image data to be displayed on the display 214. The input control unit 208 controls input of information based on a user instruction via a button or the touch panel 215, input of image data via the camera 216, and input of main body operations (at least one of a tilt and a shake) via the motion sensor 217. User interfaces (UIs) for various applications that are performed by the data processing apparatus 101 are provided to the user using the audio control unit 206, the display control unit 207, and the input control unit 208.

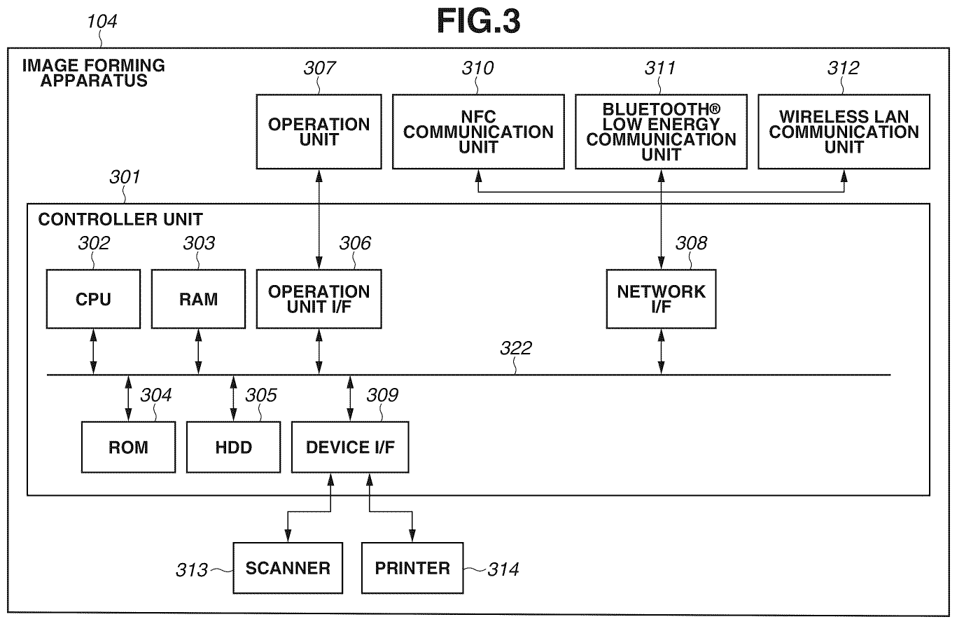

FIG. 3 is a block diagram illustrating an example of a hardware configuration of the image forming apparatus 104 according to the present exemplary embodiment.

The image forming apparatus 104 includes a controller unit 301, and the controller unit 301 controls various communication units, such as a NFC communication unit 310, a Bluetooth® Low Energy communication unit 311, and a wireless LAN communication unit 312, an operation unit 307, a scanner 313, and a printer 314. In a case where the user uses the copy function, the controller unit 301 acquires document image data by controlling the scanner 313 and prints an image on a sheet and outputs the sheet by controlling the printer 314. In a case where the user uses the scan function, the controller unit 301 acquires document image data and converts the acquired document image data into code data by controlling the scanner 313 and transmits the code data to the data processing apparatus 101 via the network 103. In a case where the user uses the print function, the controller unit 301 receives print data from the data processing apparatus 101 via the network 103. Furthermore, the controller unit 301 converts the received print data into image data, transmits the image data to the printer 314, prints an image based on the image data on a sheet, and outputs the sheet. The image forming apparatus 104 further includes a fax reception function of receiving data via an integrated services digital network (ISDN) and printing the received data and a fax transmission function of transmitting scanned data to the ISDN. An instruction to perform processing of a function described above is referred to as “job”, and the image forming apparatus 104 performs predetermined processing based on a job corresponding to a function described above.

The controller unit 301 includes a CPU 302, a RAM 303, a ROM 304, a hard disk drive (HDD) 305, an operation unit interface (operation unit UF) 306, a network OF 308, and a device interface (device UF) 309, all of which are connected together via a system bus 322.

The CPU 302 controls an entire system of the image forming apparatus 104. The RAM 303 is a system work memory for use by the CPU 302 in operating and is an image memory which temporarily stores image data. The RAM 303 also stores programs and data, such as an OS, system software, and application software. The RAM 303 stores scan image data scanned by the scanner 313 and stores print data received from the data processing apparatus 101 via the network 103. The ROM 304 stores a system boot program. The HDD 305 stores the OS, the system software, the application software, the print data, and setting data. Other storage apparatuses, such as a solid state drive (SSD), may be included in place of or in combination with the HDD 305.

The operation unit OF 306 interfaces with the operation unit 307 and outputs information to be displayed on the operation unit 307 to the operation unit 307. The operation unit OF 306 receives information input made by the user using the operation unit 307.

The network OF 308 is connected to the NFC communication unit 310, the Bluetooth® Low Energy communication unit 311, and the wireless LAN communication unit 312 and controls various types of communications with the data processing apparatus 101. The wireless LAN communication unit 312 forms a wireless LAN with the data processing apparatus 101 via the network 103. The NFC communication unit 310 and the Bluetooth® Low Energy communication unit 311 establish short-range wireless communication with the data processing apparatus 101 using wireless signals. The image forming apparatus 104 performs data communication with the data processing apparatus 101 via the network OF 308 and performs a job in response to receiving a command to perform a function of the image forming apparatus 104.

The device OF 309 connects the controller unit 301 to the scanner 313, which scans image data, and the printer 314, which prints image data, and performs image data input and output.

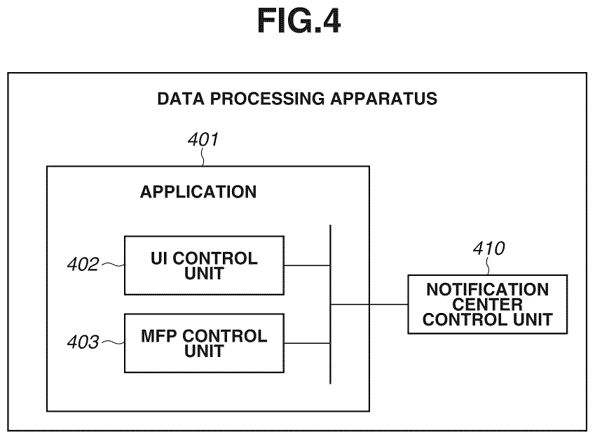

FIG. 4 is a block diagram illustrating an example of a software configuration of the data processing apparatus 101 according to the present exemplary embodiment.

An application 401 is software that the CPU 202 of the data processing apparatus 101 executes. The application 401 is installed in the data processing apparatus 101. The application 401 is read from the ROM 203 and is stored in the RAM 204. The application 401 is a program for causing the data processing apparatus 101 to function as a UI control unit 402 and a multi-function peripheral (MFP) control unit 403.

The UI control unit 402 receives setting information about a job input by the user using the touch panel 215 and connection information about the image forming apparatus 104 and transmits the received information to the MFP control unit 403. The UI control unit 402 receives a response from the MFP control unit 403 and outputs the response to the display 214 via the display control unit 207.

The MFP control unit 403 transmits requests to and receives responses from the image forming apparatus 104. The MFP control unit 403 generates job performance instruction information from the job settings received by the UI control unit 402 and transmits a job performance request to the image forming apparatus 104 via the network 103. The MFP control unit 403 acquires a job performance status from the image forming apparatus 104 via the network 103 and transmits the acquired job performance status to the UI control unit 402.

A notification center control unit 410 is part of system software of the data processing apparatus 101 and controls a notification center. The notification center is a function (notification function) of gathering notifications from the applications and displaying the gathered notifications at one location on the data processing apparatus 101. The notification center control unit 410 displays messages at the notification center based on instructions from the application 401 and calls an application corresponding to a message at the notification center.

The notification center control unit 410 is read from the ROM 203 and is stored in the RAM 204. The notification center control unit 410 is executed by the CPU 202 and causes the data processing apparatus 101 to realize the function of the notification center control unit 410.

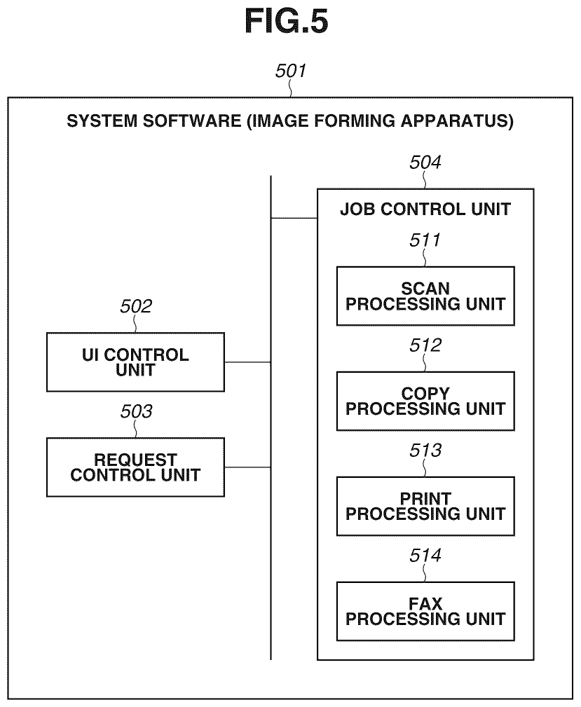

FIG. 5 is a block diagram illustrating an example of a software configuration of the image forming apparatus 104 according to the present exemplary embodiment.

System software 501 is executed by the CPU 302 of the image forming apparatus 104. The system software 501 is read from the HDD 305 and is stored in the RAM 303. The system software 501 causes the image forming apparatus 104 to function as a UI control unit 502, a request control unit 503, and a job control unit 504.

The UI control unit 502 receives information input by the user using the operation unit 307 and performs screen control.

The request control unit 503 performs control corresponding to requests received from the data processing apparatus 101. More specifically, the request control unit 503 performs processing corresponding to a received request and transmits a processing result as a response to the data processing apparatus 101.

The job control unit 504 controls processing units, such as a scan processing unit 511, a copy processing unit 512, a print processing unit 513, and a fax processing unit 514, and performs various jobs based on the job settings. In a case where the job control unit 504 receives a job performance stop instruction from the UI control unit 502 or the request control unit 503, the job control unit 504 stops a job being performed.

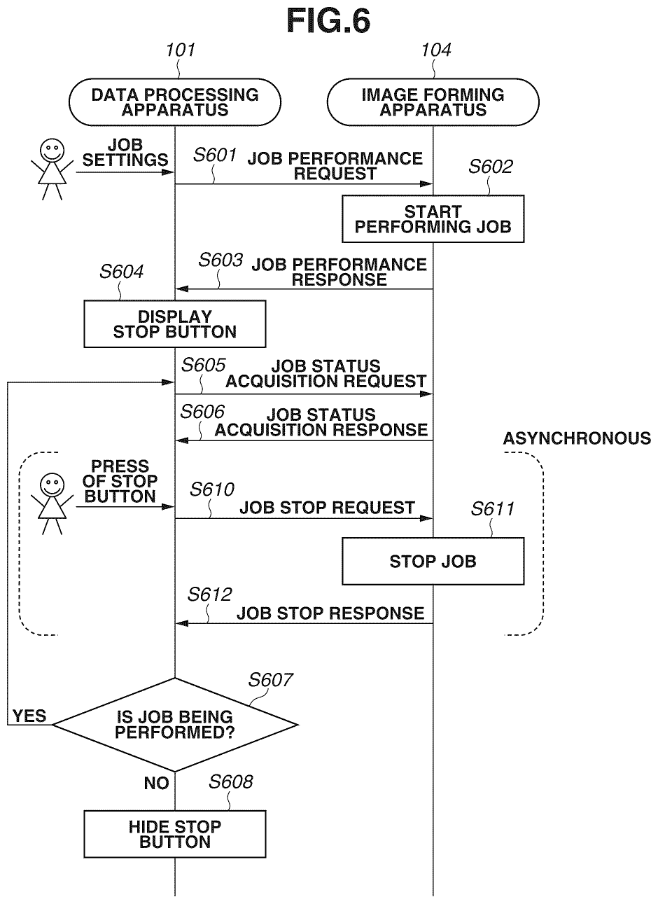

FIG. 6 is a sequence diagram illustrating a communication between the data processing apparatus 101 and the image forming apparatus 104 according to the first exemplary embodiment. In FIG. 6, the letter “S” indicates “step”.

In step S601, the data processing apparatus 101 transmits a job performance request including job setting values input by the user to the image forming apparatus 104.

In step S602, the image forming apparatus 104 starts performing a job based on the job performance request received from the data processing apparatus 101.

Next in step S603, the image forming apparatus 104 transmits, to the data processing apparatus 101, a response (hereinafter, “job performance response”) to the job performance request.

In step S604, the data processing apparatus 101 displays, on the display 214, a button for issuing an instruction to stop performing the job (hereinafter, such a button is referred to as “stop button”).

The operations in steps S605 to S607 correspond to a repeat process that is performed by the data processing apparatus 101 to monitor a job performance status (hereinafter, “job status”) of the image forming apparatus 104, and the data processing apparatus 101 transmits a job status inquiry to the image forming apparatus 104 at regular intervals.

The operations in steps S610 to S612 correspond to a process that is performed in the wake of a detection of the stop button having pressed by the user. The operations in steps S610 to S612 are performed asynchronously during the repeat process of steps S605 to S607.

The operations in steps S605 to S607 will be described in detail below.

Initially in step S605, the data processing apparatus 101 transmits a job status acquisition request to the image forming apparatus 104 to inquire about the job status.

In step S606, the image forming apparatus 104 acquires the job status based on the job status acquisition request received from the data processing apparatus 101 and transmits the acquired job status as a job status acquisition response to the data processing apparatus 101.

In step S607, the data processing apparatus 101 determines, based on the job status received from the image forming apparatus 104, whether the job corresponding to the job performance request in step S601 is being performed. In a case where the job status does not indicate that the job performance has ended, the data processing apparatus 101 determines that the job is being performed (YES in step S607), and the processing returns to step S605.

In a case where the job status indicates that the job performance has ended, the data processing apparatus 101 determines that the job is not being performed (NO in step S607), and the processing proceeds to step S608.

In step S608, the data processing apparatus 101 hides the stop button displayed on the display 214 in step S604.

Next, the operations in steps S610 to S612 will be described in detail below.

In a case where the data processing apparatus 101 detects the stop button having been pressed by the user while any of the operations in steps S605 to S607 is being performed, in step S610, the data processing apparatus 101 transmits a job stop request to the image forming apparatus 104 to instruct the image forming apparatus 104 to stop performing the job.

In step S611, the image forming apparatus 104 stops performing the job based on the job stop request. Then, in step S612, the image forming apparatus 104 transmits, to the data processing apparatus 101, a response to the job stop request (hereinafter, such a response is referred to as “job stop response”).

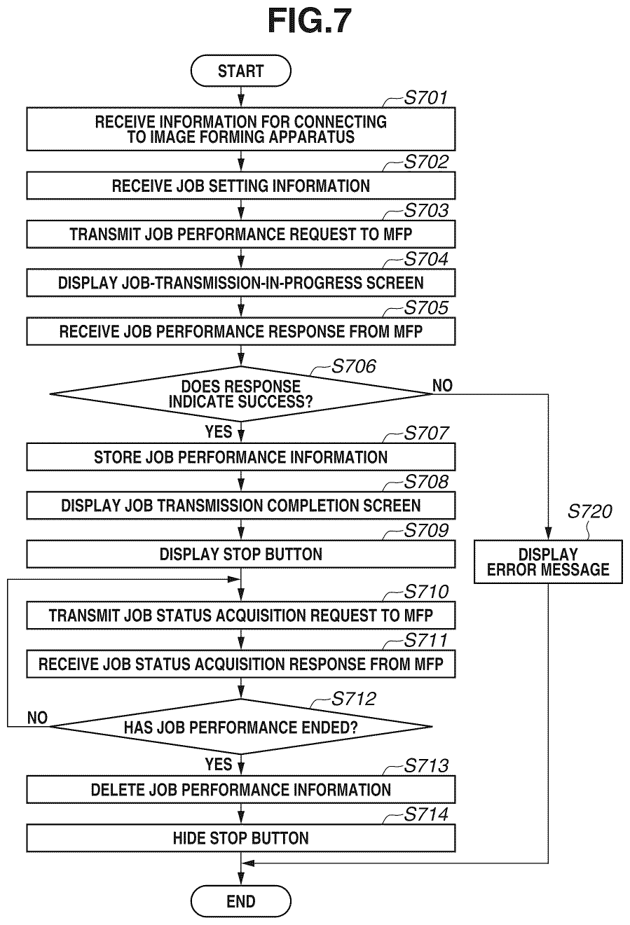

Processing that the data processing apparatus 101 according to the present exemplary embodiment performs will be described below with reference to FIGS. 7, 8, and 9A to 9E.

FIG. 7 is a flowchart illustrating an example of a job performance instruction process that the data processing apparatus 101 performs according to the first exemplary embodiment. The flowchart in FIG. 7 corresponds to the process performed by the data processing apparatus 101 in steps S601 to S608 in the sequence diagram in FIG. 6. The flowchart in FIG. 7 is realized by the CPU 202 of the data processing apparatus 101 reading programs for realizing control modules from the ROM 203 or the storage device 209 to the RAM 204 and executing the read programs. In FIG. 7, the letter “S” indicates “step”.

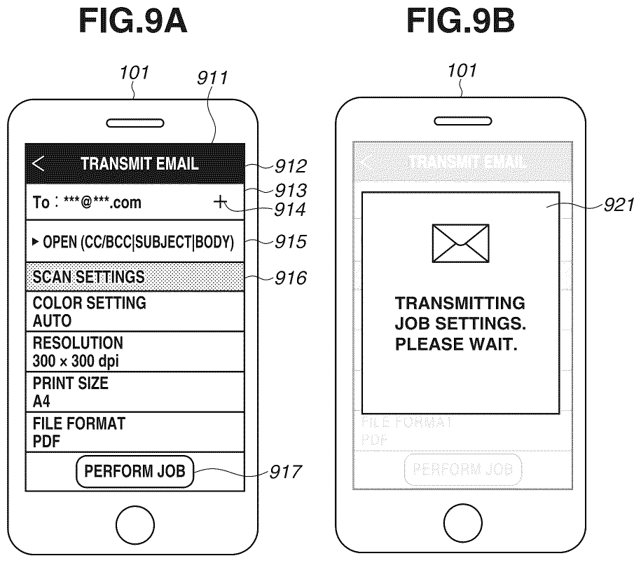

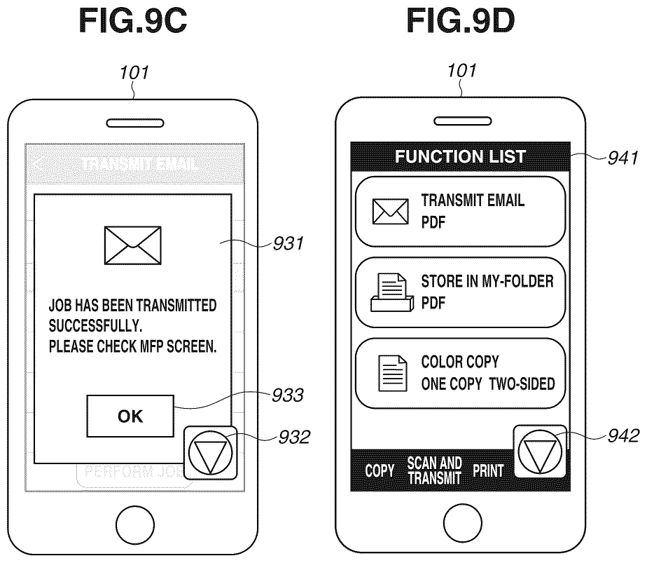

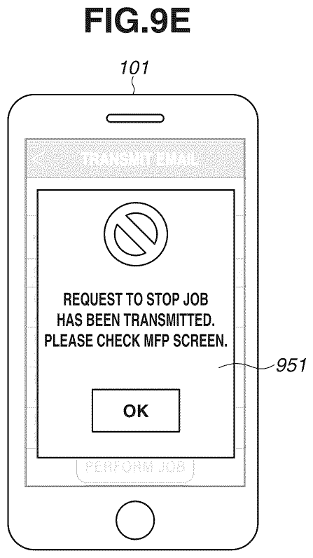

FIGS. 9A to 9E are diagrams each illustrating an example of a screen displayed by the application 401 of the data processing apparatus 101 according to the first exemplary embodiment.

In step S701, the UI control unit 402 receives information (e.g., Internet Protocol (IP) address) for connecting to the image forming apparatus 104 by which the job is to be performed, based on a screen operation on the application 401 by the user. Instead of receiving information for connecting to the image forming apparatus 104 that is input by the user, a search for image forming apparatuses connected to the network 103 may be performed using the wireless LAN communication unit 212. In a case where authentication is to be performed for use of the image forming apparatus 104, information to be used for the authentication, such as user ID and password, (hereinafter, the information to be used for the authentication is referred to as “authentication information”) is received at the same time. In the subsequent steps, the data processing apparatus 101 communicates with the image forming apparatus 104 using the information received in step S701.

Next in step S702, the UI control unit 402 receives job setting information based on user operations on a job setting screen.

FIG. 9A illustrates an example of a job setting screen.

Job settings for transmitting, via email, an image acquired by scanning a paper document by the image forming apparatus 104 are settable with a job setting screen 911 illustrated as an example in FIG. 9A.

A title 912 displays a title and includes a button for cancelling the settings and returning to a previous screen. In an email address setting area 913, a transmission destination email address is able to be input using a software keyboard. A press of an address book activation button 914 activates an address book of the data processing apparatus 101. In a case where the user selects an email address from the address book, the selected email address is displayed in the email address setting area 913. A plurality of email addresses is settable. A press of an open button 915 shifts a screen to a screen display with which items such as carbon copy (CC), blind CC (BCC), subject, body, and file name are settable and the items are able to be input.

In a scan settings area 916, buttons corresponding to scan settings, such as a color setting and a resolution, for scanning performed by the image forming apparatus 104 are arranged, and a job setting is changeable by pressing the corresponding button.

In response to detecting a press of a perform job button 917, the UI control unit 402 receives information set via the job setting screen 911 as job setting information.

Next in step S703, the MFP control unit 403 transmits a job performance request including the job setting information received in step S702 to the image forming apparatus 104.

Next in step S704, the UI control unit 402 displays, on the display 214, a screen indicating that the job settings are being transmitted (hereinafter, such a screen is referred to as “job-transmission-in-progress screen”) to the image forming apparatus 104.

FIG. 9B illustrates an example of a job-transmission-in-progress screen.

A message area 921 is an area for displaying information indicating that the job settings are being transmitted to the image forming apparatus 104.

Next, in step S705, the MFP control unit 403 receives a job performance response from the image forming apparatus 104 as a response to step S703. The job performance response includes information indicating whether the job performance request has been successful and a job identifier (job ID) for identifying the job.

Next in step S706, the MFP control unit 403 determines whether the job performance response indicates success. If the MFP control unit 403 determines that the job performance response does not indicate success (NO in step S706), the processing proceeds to step S720.

In step S720, the UI control unit 402 displays, on the display 214, information indicating an error of the job performance instruction, and the processing in the flowchart is ended.

If the MFP control unit 403 determines that the job performance response indicates success (YES in step S706), the processing proceeds to step S707.

In step S707, the MFP control unit 403 stores, in the RAM 204 or the storage device 209, connection information about the image forming apparatus 104, which is the transmission destination of the job performance request, and the job ID included in the received job performance response as job performance information.

In step S708, the UI control unit 402 displays, on the display 214, a screen indicating that the job performance request has been successful (hereinafter, such a screen is referred to as “job transmission completion screen”).

In step S709, the UI control unit 402 displays the stop button on the display 214. The stop button is displayed regardless of screen transitions in the application 401, and unless a hiding process in step S714 described below is performed, the stop button is constantly displayed while the application 401 is displayed on the display 214.

FIGS. 9C and 9D each illustrate an example of a stop button.

FIG. 9C illustrates an example of a job transmission completion screen.

A message area 931 is an area for displaying information indicating that the job performance request has been successful. A button 932 is a stop button and is displayed to be superposed on the message area 931. A button 933 is a button for closing the job transmission completion screen. In response to a press of the button 933 by the user having been detected, the UI control unit 402 displays a function list screen illustrated in FIG. 9D on the display 214.

FIG. 9D illustrates an example of a function list screen.

A list area 941 is an area for displaying a list of functions of the application 401. A button 942 is a stop button (corresponding to the button 932) and is displayed regardless of a screen transition from FIG. 9C to FIG. 9D. The button 942 is displayed to be superposed on the list area 941.

The function list screen enables issuance of an instruction to perform second processing, to be performed by the image forming apparatus 104, different from the job (transmitted job) that is stoppable by operating the button 942 to the image forming apparatus 104. For example, touching the display item “transmit email” shifts the scree to the job setting screen in FIG. 9A, and an instruction to transmit a new email (processing of performing scanning and transmitting the scanned material via email by the image forming apparatus 104) is issuable. Touching the display item “store in my-folder” shifts the screen to the job setting screen, and an instruction to perform scanning and to store the scanned data in a predetermined folder is issuable to the image forming apparatus 104. Touching the display item “color copy” shifts the screen to the job setting screen, and an instruction to perform scanning, to print the scanned data, and to output the printed material is issuable to the image forming apparatus 104. In this way, the button 942 is kept displayed even during an operation for the second processing, thus preventing a situation where the display for issuing an instruction to stop the transmitted job disturbs an operation to issue a next instruction to perform different processing. The function list screen is different from the screen indicating the job performance status.

Next in step S710, the MFP control unit 403 transmits a job status acquisition request to the image forming apparatus 104.

Next in step S711, the MFP control unit 403 receives, from the image forming apparatus 104, a job status acquisition response as a response to the job status acquisition request transmitted in step S710. The job status acquisition response includes information indicating whether the job corresponding to the job performance request transmitted in step S703 is being performed by the image forming apparatus 104.

Next in step S712, the MFP control unit 403 determines whether the job performance has ended based on the information included in the job status acquisition response. If the MFP control unit 403 determines that the job performance has not ended (NO in step S712), the processing proceeds to step S710.

On the other hand, if the MFP control unit 403 determines that the job performance has ended (YES in step S712), the processing proceeds to step S713.

In step S713, the MFP control unit 403 deletes the job performance information stored in step S707 from the RAM 204 or the storage device 209.

In step S714, the UI control unit 402 hides the stop button, and ends the processing in the flowchart. More specifically, the stop button is hidden at a timing corresponding to the end of the job.

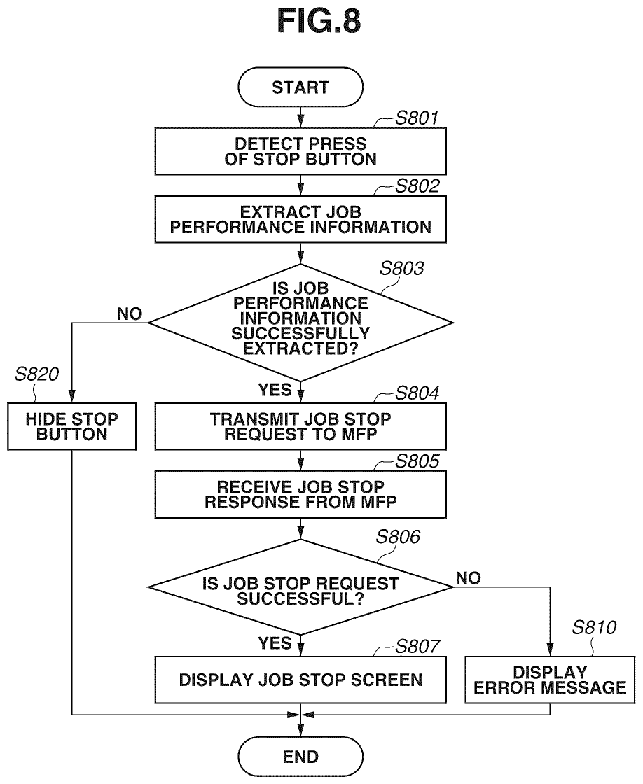

The stop button may be displayed constantly after the job performance with the operation in step S714 not being performed. In such a case, the stop button can be configured to be hidden at a press of the stop button (step S820 in FIG. 8, described below). In such a case, the stop button is hidden with the absence of the job to be stopped at a timing corresponding to an instruction using the stop button.

FIG. 8 is a flowchart illustrating an example of a job stop instruction process that the data processing apparatus 101 performs according to the first exemplary embodiment. The flowchart in FIG. 8 corresponds to the operations performed by the data processing apparatus 101 in steps S610 to S612 in the sequence diagram in FIG. 6. Further, the flowchart in FIG. 8 is realized by the CPU 202 of the data processing apparatus 101 reading programs for realizing the control modules from the ROM 203 or the storage device 209 to the RAM 204 and executing the read programs. In FIG. 8, the letter “S” indicates “step”.

In step S801, the UI control unit 402 detects a press of the stop button (job stop operation) by the user. Instead of pressing the stop button, the user may operate the main body using the motion sensor 217. For example, in a case where the data processing apparatus 101 is a mobile terminal, such as a smartphone, the processing can proceed to the subsequent step in response to a detection of an operation of shaking the mobile terminal back and forth.

In step S802, the MFP control unit 403 extracts the job performance information (job performance information stored in step S707 in FIG. 7) from the RAM 204 or the storage device 209 based on the detection in step S801.

Next, in step S803, the MFP control unit 403 determines whether the job performance information is successfully extracted. If the MFP control unit 403 fails to extract the job performance information (NO in step S803), the processing proceeds to step S820.

In step S820, the UI control unit 402 hides the stop button, and the process in the flowchart is ended.

If the MFP control unit 403 has successfully extracted the job performance information (YES in step S803), the processing proceeds to step S804.

In step S804, the MFP control unit 403 extracts the connection information about the image forming apparatus 104 from the job performance information and transmits a job stop request to the image forming apparatus 104. The job stop request includes the job ID and the authentication information.

Next in step S805, the MFP control unit 403 receives, from the image forming apparatus 104, a job stop response as a response to step S804. The job stop response includes information indicating whether the job stop request is successful.

Next in step S806, the MFP control unit 403 determines whether the job stop request is successful based on the job stop response. If the MFP control unit 403 determines that the job stop request is unsuccessful (NO in step S806), the processing proceeds to step S810.

In step S810, the UI control unit 402 displays, on the display 214, information indicating an error of the job stop request, and ends the processing in the flowchart.

If the MFP control unit 403 determines that the job stop request is successful (YES in step S806), the processing proceeds to step S807.

In step S807, the UI control unit 402 displays, on the display 214, a screen (hereinafter, “job stop screen”) indicating that the job stop request has been transmitted, and ends the processing in the flowchart.

FIG. 9E illustrates an example of a job stop screen.

A message area 951 is an area for displaying information indicating that the job stop request has been transmitted.

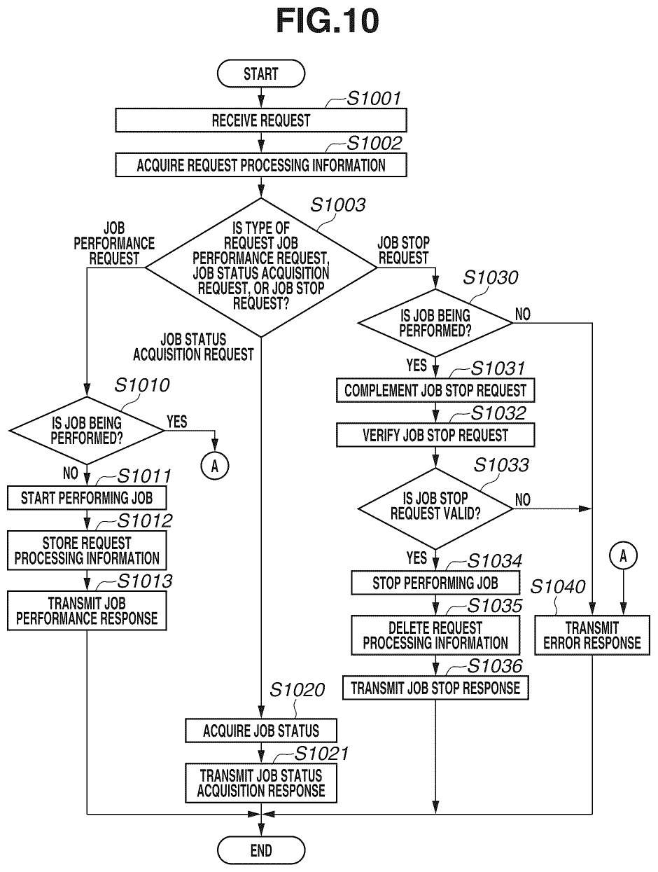

Processing that the image forming apparatus 104 according to the present exemplary embodiment performs will be described below with reference to FIG. 10.

FIG. 10 is a flowchart illustrating an example of the processing that the image forming apparatus 104 performs. The flowchart in FIG. 10 corresponds to the processing performed by the image forming apparatus 104 in the sequence diagram in FIG. 6. Further, the processing in the flowchart in FIG. 10 is realized by the CPU 302 of the image forming apparatus 104 reading programs for realizing the control modules from the ROM 304 or the HDD 305 to the RAM 303 and executing the read programs. In FIG. 10, the letter “S” indicates “step”.

In step S1001, the request control unit 503 receives a request transmitted from the data processing apparatus 101 via the network 103. Examples the request are the information transmitted in steps S703, S710, and S804.

Next in step S1002, the request control unit 503 extracts information about processing for the request (hereinafter, the information is referred to as “request processing information”) from the RAM 303 or the HDD 305. The request processing information is stored in step S1012 described below and includes the IP address of the data processing apparatus 101, which is the request source, the authentication information, and the job ID of the job being performed based on the received request.

Next in step S1003, the request control unit 503 determines the type of the request received in step S1001. In a case where the request control unit 503 determines that the type of the request is “job performance request” (“job performance request” in step S1003), the processing proceeds to step S1010. In a case where the request control unit 503 determines that the type of the request is “job status acquisition request” (“job status acquisition request” in step S1003), the processing proceeds to step S1020. In a case where the request control unit 503 determines that the type of the request is “job stop request” (“job stop request” in step S1003), the processing proceeds to step S1030.

First, the case where the type of the request is “job performance request” will be described below.

In step S1010, the request control unit 503 determines whether the job is being performed by the image forming apparatus 104. If the request control unit 503 determines that the job is being performed (YES in step S1010), the processing proceeds to step S1040.

In step S1040, the request control unit 503 transmits, to the data processing apparatus 101, an error response indicating an error of the request received in step S1001, and the process in the flowchart is ended.

If the request control unit 503 determines that the job is not being performed (NO in step S1010), the processing proceeds to step S1011.

In step S1011, the job control unit 504 starts performing the job based on the job settings included in the job performance request received in step S1001 and issues a job ID.

Next in step S1012, the request control unit 503 stores, in the RAM 303 or the HDD 305, request processing information including the job ID issued in step S1001, the IP address of the data processing apparatus 101, which is the request source, and the authentication information.

In step S1013, the request control unit 503 transmits, to the data processing apparatus 101, a job performance response to the job performance request received in step S1001, and the process in the flowchart is ended.

Secondary, the case where the type of the request is “job status acquisition request” in step S1003 will be described below.

In step S1020, the request control unit 503 acquires, from the job control unit 504, the job status of the job corresponding to the job ID included in the request processing information acquired in step S1002.

Next in step S1021, the request control unit 503 transmits, to the data processing apparatus 101, a job status acquisition response including the job status acquired in step S1020 to the job status acquisition request received in step S1001, and ends the processing in the flowchart.

Thirdly, the case where the type of the request is “job stop request” in step S1003 will be described below.

In step S1030, the request control unit 503 determines whether the job is being performed by the image forming apparatus 104. If the request control unit 503 determines that the job is not being performed (NO in step S1030), the processing proceeds to step S1040. In step S1040, the request control unit 503 transmits an error response to the data processing apparatus 101, and ends the processing in the flowchart.

If the request control unit 503 determines that the job is being performed (YES in step S1030), the processing proceeds to step S1031.

In step S1031, in a case where the job stop request received in step S1001 lacks information, the request control unit 503 complements the job stop request using the request processing information. For example, in a case where the request includes no job ID, the job ID included in the request processing information is used. In a case where the request includes no authentication information, the authentication information included in the request processing information is used. A condition for determining whether to complement a job stop request may be provided. For example, the job stop request is complemented only in a case where the IP address of the transmission source of the job stop request matches the IP address included in the request processing information (i.e., a case where the request is transmitted from the same data processing apparatus 101). Alternatively, the job stop request is complemented only in a case where authentication information included in the job stop request matches the authentication information included in the request processing information (i.e., a case where the request is provided by the same user).

Next in step S1032, the request control unit 503 verifies whether the job stop request received in step S1001 is valid. For example, in a case where the job ID included in the job stop request does not match the job ID of the job being performed, the job stop request is invalid. In a case where the authentication information included in the job stop request does not match the authentication information included in the request processing information (i.e., a case where the job stop instruction is issued by a user different from the user having issued the instruction to perform the job), the job stop request is invalid.

Next in step S1033, the processing branches based on a verification result in step S1032. If the request control unit 503 determines that the job stop request is invalid (NO in step S1033), the processing proceeds to step S1040. In step S1040, the request control unit 503 transmits an error response to the data processing apparatus 101, and ends the processing in the flowchart.

If the request control unit 503 determines that the job stop request is valid (YES in step S1033), the processing proceeds to step S1034.

In step S1034, the job control unit 504 stops performing the job corresponding to the job ID included in the job stop request or the job ID added in step S1031.

Next in step S1035, the request control unit 503 deletes the request processing information stored in the RAM 303 or the HDD 305.

In step S1036, the request control unit 503 transmits a job stop response to the data processing apparatus 101, and ends the processing in the flowchart.

According to the foregoing description, the job performance request is processed as an error in a case where the job is being performed in step S1010. Alternatively, instead of processing the job performance request as an error in a case where the job is being performed, the job based on the job performance request may be held as a pending job, and once the preceding job ends, the pending job may be started. In such a case, in response to a job stop request being received, which one of the job being performed and the pending job is the job to be stopped is determined based on the job ID included in the job stop request, and the job determined to be stopped is then stopped.

As described above, in a case where the job settings are transmitted from the data processing apparatus 101 to the image forming apparatus 104, means for issuing an instruction to stop the job (stop button) from the data processing apparatus 101 is displayed regardless of screen shifts in the application 401. Thus, the data processing apparatus 101 is released after the job transmission (without being occupied until the job ends), thus preventing impairment of the usability. Even in a case where the screen of the application 401 displayed on the data processing apparatus 101 is closed, it is possible to stop the job from the data processing apparatus 101 using the stop button. This enables the user to stop the job without operating the main body of the image forming apparatus 104. As described above, it is possible for the user to easily issue a job stop instruction from the data processing apparatus 101, so that usability improves significantly.

A second exemplary embodiment of the present disclosure will be described below. In the first exemplary embodiment, in a case where a job performance request is transmitted from the data processing apparatus 101 to the image forming apparatus 104, the stop button (button-shaped user interface) for issuing an instruction to stop the job is displayed in the screen of the application 401. In the second exemplary embodiment, a job stop instruction is issuable from an external source external to the application 401, which will be described below. The second exemplary embodiment is a modification of the first exemplary embodiment, and thus only differences between the second exemplary embodiment and the first exemplary embodiment will be described below.

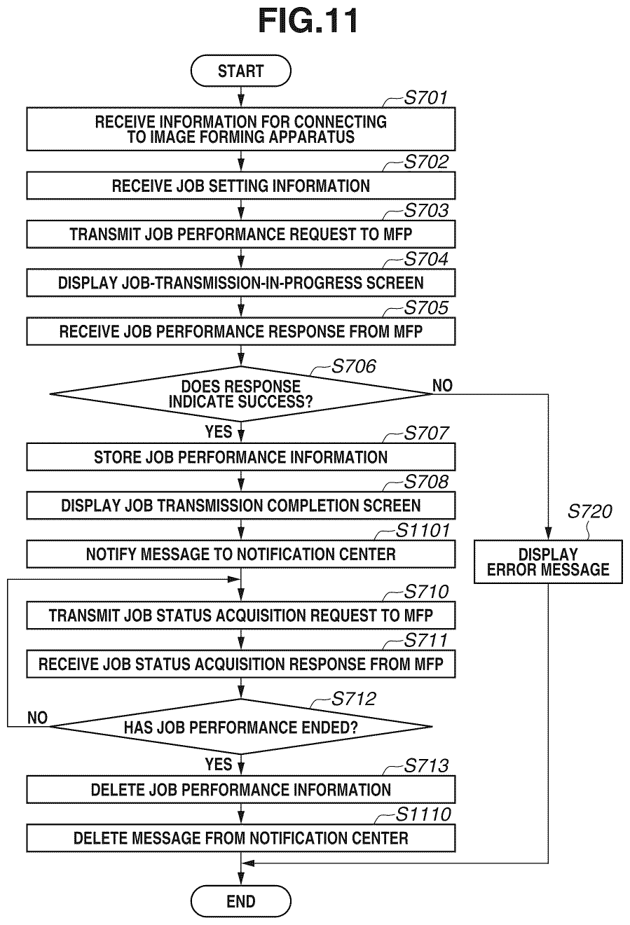

FIG. 11 is a flowchart illustrating an example of a job performance instruction process that the data processing apparatus 101 performs according to the second exemplary embodiment. The flowchart in FIG. 11 is a modification of the flowchart in FIG. 7. More specifically, the flowchart in FIG. 11 is realized by the CPU 202 of the data processing apparatus 101 reading programs for realizing the control modules from the ROM 203 or the storage device 209 to the RAM 204 and executing the read programs. In FIG. 11, the letter “S” indicates “step”. The steps in FIG. 11 same as the steps in FIG. 7 are each given the same step number. Only differences between FIGS. 7 and 11 will be described below.

In the job performance instruction processing according to the second exemplary embodiment, a message for stopping performance of the job is notified to the notification center, instead of displaying the stop button. More specifically, in step S1101 after the processing of step S708, the UI control unit 402 issues, to the notification center control unit 410, an instruction to notify a message for stopping performance of the job (hereinafter, “job stop notification”) to the notification center. At this time, a stop instruction is provided as a parameter for a case where the application 401 is called in response to the job stop notification. The notification center control unit 410 displays the job stop notification at the notification center based on the instruction from the UI control unit 402.

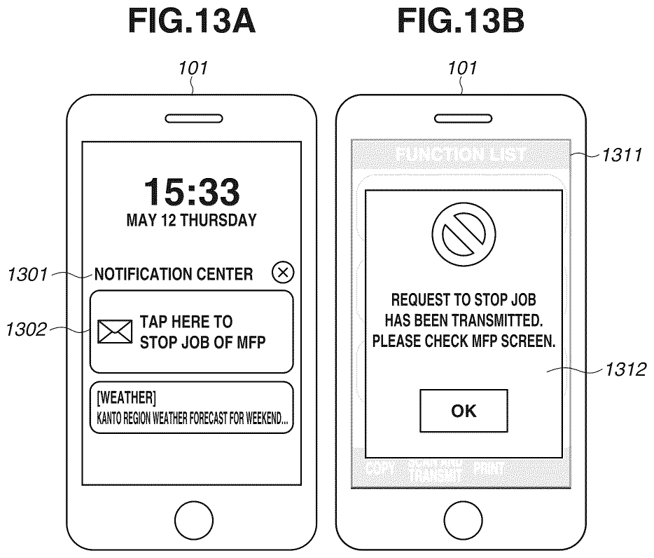

FIG. 13A illustrates an example of a notification center screen.

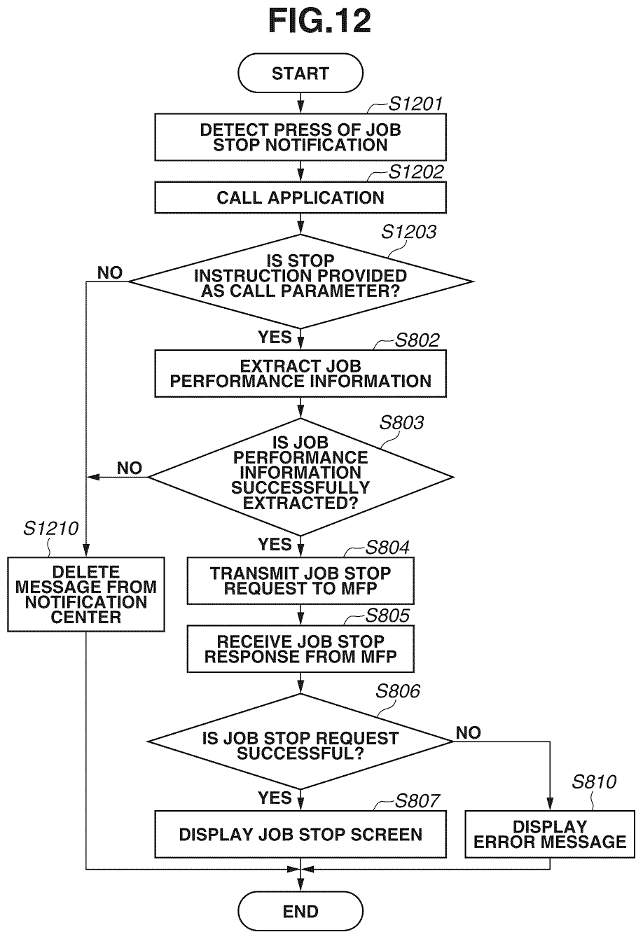

A notification center area 1301 is used for displaying various notifications notified to the notification center. A notification 1302 is a job stop notification. In a case where the notification center control unit 410 detects a press of the notification 1302 by the user, processing illustrated in a flowchart in FIG. 12 is performed.

In the job performance instruction process according to the second exemplary embodiment, the job stop notification is deleted from the notification center, instead of hiding the stop button. More specifically, in step S1110 after the operation in step S713, the UI control unit 402 issues an instruction to delete the job stop notification from the notification center to the notification center control unit 410. The notification center control unit 410 deletes the job stop notification from the notification center based on the instruction from the UI control unit 402.

The job stop notification may be displayed constantly after the job performance without performing step S1110. In such a case, the job stop notification may be hidden at a press of the notification 1302 serving as the job stop notification (step S1210 in FIG. 12 described below).

FIG. 12 is a flowchart illustrating the job stop instruction process that the data processing apparatus 101 performs according to the second exemplary embodiment. The flowchart in FIG. 12 is a modification of the flowchart in FIG. 8. More specifically, the flowchart in FIG. 12 is realized by the CPU 202 of the data processing apparatus 101 by reading programs for realizing the control modules from the ROM 203 or the storage device 209 to the RAM 204 and executing the read programs. In FIG. 12, the letter “S” indicates “step”. The steps in FIG. 12 same as the steps in FIG. 8 are each given the same step number. Only differences between FIGS. 8 and 12 will be described below.

In step S1201, the notification center control unit 410 detects a press of the job stop notification (job stop operation). In step S1202, the notification center control unit 410 calls the application 401 in response to the detection in step S1201, and switches the screen to the application 401. At this time, the notification center control unit 410 provides a stop instruction as a call parameter of the application 401.

Next in step S1203, the UI control unit 402 determines whether a stop instruction is provided as a call parameter of the application 401. If the UI control unit 402 determines that a stop instruction is provided (YES in step S1203), the processing proceeds to step S802.

If the UI control unit 402 determines that no stop instruction is provided (NO in step S1203), the processing proceeds to step S1210.

In step S1210, the UI control unit 402 issues, to the notification center control unit 410, an instruction to delete the job stop notification from the notification center, and ends the processing in the flowchart.

FIG. 13B illustrates an example of a screen in a case where a job stop instruction is issued via the notification center.

A screen 1311 displays the application 401. A message area 1312 is used for displaying information indicating that a job stop request has been transmitted.

As described above, the data processing apparatus 101 is released after the job transmission (without being occupied until the job ends), thus preventing impairment of the usability. Even in a case where the screen of the application 401 displayed on the data processing apparatus 101 is closed, it is possible to stop the job from the data processing apparatus 101 using the notification at the notification center. This enables the user to stop the job without operating the main body of the image forming apparatus 104. In such a manner, it is possible for the user to issue a job stop instruction from the notification center of the data processing apparatus 101, so that usability improves significantly.

According to each exemplary embodiment described above, a UI for issuing an instruction to stop a job for an image forming apparatus that has been started based on an instruction from a mobile terminal is displayed regardless of screen sifts in an application. Thus, it is possible to stop, using the mobile terminal, the job in the image forming apparatus that has been started in response to an instruction from the mobile terminal, easily and promptly. Thus, facilitating of the issuance of an instruction to stop a job started from a mobile terminal improves the usability significantly.

Configurations and descriptions of various types of data described above are not limited to those described above, and the data can have various configurations and descriptions for various uses or purposes of use.

While exemplary embodiments of the present disclosure have been described above, the present disclosure is also implementable as, for example, a system, an apparatus, a method, a program, or a storage medium. More specifically, the present disclosure is applicable to a system including a plurality of devices or to an apparatus configured with a single device.

Any combinations of the above-described exemplary embodiments are also encompassed within the scope of the present disclosure.

The present disclosure facilitates issuance of an instruction to stop a job that has been executed in response to an instruction from a mobile terminal, thus improving usability.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-140521, filed Sep. 5, 2022, which is hereby incorporated by reference herein in its entirety.

What is claimed is:

1. A non-transitory computer-readable storage medium storing a program for executing a method for controlling an information processing apparatus capable of communicating with an image processing apparatus, the method comprising:
performing control to transmit, to the image processing apparatus, a performance instruction to perform a job; and
performing control to display, regardless of a screen shift in an application program for receiving the performance instruction, a specific display item configured to receive a stop operation for transmitting, to the image processing apparatus, a stop instruction to instruct the image processing apparatus to stop performing the job based on the performance instruction, the program included in the application program.

2. The non-transitory computer-readable storage medium according to claim 1, wherein the control to display the specific display item is performed so that the specific display item is displayed on a specific screen configured to receive, from a user, an instruction operation relating to second processing performance of which is instructable by the application program, the second processing being different from the job based on the performance instruction.

3. The non-transitory computer-readable storage medium according to claim 1, wherein the control to display the specific display item is performed so that the specific display item is displayed on a function list screen including a plurality of functions performance of which is instructable by the application program, the plurality of functions being different from the job based on the performance instruction.

4. The non-transitory computer-readable storage medium according to claim 1, wherein the control to display the specific display item is performed so that the specific display item is displayed with the specific display item superposing on other display items.

5. The non-transitory computer-readable storage medium according to claim 1, the method further comprising:
receiving, from the image processing apparatus, information indicating a status of the job based on the performance instruction; and
performing control to hide the specific display item in a case where the received information indicating the status indicates that the job based on the performance instruction has ended.

6. The non-transitory computer-readable storage medium according to claim 5, wherein, in a case where a screen is displayed by the application program, after the display of the specific display item is started, the display of the specific display item continues unless the control to hide the specific display item is performed.

7. The non-transitory computer-readable storage medium according to claim 1, the method further comprising performing control to transmit, to the image processing apparatus, information corresponding to a stop request to stop the job based on the performance instruction in response to a user operation having been performed on the specific display item.

8. The non-transitory computer-readable storage medium according to claim 7, the method further comprising performing control to receive, from the image processing apparatus, a response to the stop request and to present a display based on the received response.

9. The non-transitory computer-readable storage medium according to claim 1, wherein the application program is an application program of a smartphone.

10. The non-transitory computer-readable storage medium according to claim 1, wherein the specific display item is displayed on a screen different from a screen indicating a performance status of the job transmitted to the image processing apparatus.

11. The non-transitory computer-readable storage medium according to claim 1, wherein the control to display the specific display item is performed so that the specific display item is displayed without a user operation of displaying the specific display item after the performance instruction is transmitted to the image processing apparatus.

12. A non-transitory computer-readable storage medium storing a program for executing a method for controlling an information processing apparatus capable of communicating with an image processing apparatus, the method comprising:
performing control to transmit, to the image processing apparatus, a performance instruction to perform a job; and
performing control to display, on a specific screen configured to receive, from a user, an instruction operation relating to second processing performance of which is instructable by an application program, a specific display item configured to receive a stop operation for transmitting, to the image processing apparatus, a stop instruction to instruct the image processing apparatus to stop performing the job based on the performance instruction, the second processing being different from the job based on the performance instruction, the program included in the application program.

13. The non-transitory computer-readable storage medium according to claim 12, wherein the specific screen is a function list screen including a plurality of functions performance of which is instructable by the application program.

14. The non-transitory computer-readable storage medium according to claim 12, wherein the control to display the specific display item is performed so that the specific display item is displayed with the specific display item superposing on other display items.

15. The non-transitory computer-readable storage medium according to claim 12, the method further comprising:
receiving, from the image processing apparatus, information indicating a status of the job based on the performance instruction; and
performing control to hide the specific display item in a case where the received information indicating the status indicates that the job based on the performance instruction has ended.

16. The non-transitory computer-readable storage medium according to claim 15, wherein, in a case where a screen is displayed by the application program, after the display of the specific display item is started, the display of the specific display item continues unless the control to hide the specific display item is performed.

17. The non-transitory computer-readable storage medium according to claim 12, the method further comprising performing control to transmit, to the image processing apparatus, information corresponding to a stop request to stop the job based on the performance instruction in response to a user operation having been performed on the specific display item.

18. The non-transitory computer-readable storage medium according to claim 12, wherein the application program is an application program of a smartphone.

19. A non-transitory computer-readable storage medium storing a program for executing a method for controlling an information processing apparatus capable of communicating with an image processing apparatus, the method comprising:
performing control to transmit, to the image processing apparatus, a performance instruction to perform a job; and
performing control to display, on a notification screen configured to display a notification relating to a plurality of pieces of application software, a specific display item configured to receive a stop operation for transmitting, to the image processing apparatus, a stop instruction to instruct the image processing apparatus to stop performing the job based on the performance instruction.

20. The non-transitory computer-readable storage medium according to claim 19, wherein the specific display item is displayed as a notification relating to the program together with a notification relating to a second application software different from a first application program on the notification screen, the program included in the first application program.

21. The non-transitory computer-readable storage medium according to claim 19, the method further comprising performing, in response to a user operation having been performed on the specific display item, control to activate a first application program and to transmit, to the image processing apparatus, information corresponding to a stop request to stop the job based on the performance instruction, the program included in the first application program configured to receive the performance instruction.

22. The non-transitory computer-readable storage medium according to claim 21, wherein, in activating the first application program in response to the user operation having been performed on the specific display item, a parameter indicating that the stop request is to be transmitted is provided, and the first application program is called and activated.

23. The non-transitory computer-readable storage medium according to claim 19, the method further comprising:
receiving, from the image processing apparatus, information indicating a status of the job based on the performance instruction; and
performing control to hide the specific display item in a case where the received information indicating the status indicates that the job based on the performance instruction has ended.

24. The non-transitory computer-readable storage medium according to claim 19, wherein the notification screen is a screen displayed by a function of system software different from a first application program, the program included in the first application program.

25. The non-transitory computer-readable storage medium according to claim 19, wherein a first application is an application program of a smartphone, the program included in the first application program.

26. A method for controlling an information processing apparatus capable of communicating with an image processing apparatus, the method comprising:
performing control to transmit, to the image processing apparatus, a performance instruction to perform a job; and
performing control to display, regardless of a screen shift in an application program for receiving the performance instruction, a specific display item configured to receive a stop operation for transmitting, to the image processing apparatus, a stop instruction to instruct the image processing apparatus to stop performing the job based on the performance instruction.

27. An information processing apparatus capable of communicating with an image processing apparatus, the information processing apparatus comprising:
at least one memory and at least one processor and/or at least one circuit which function as:
a transmission control unit configured to perform control to transmit, to the image processing apparatus, a performance instruction to perform a job; and
a display control unit configured to perform control to display, regardless of a screen shift in an application program for receiving the performance instruction, a specific display item configured to receive a stop operation for transmitting, to the image processing apparatus, a stop instruction to instruct the image processing apparatus to stop performing the job based on the performance instruction.

28. An image processing apparatus capable of communicating with an information processing apparatus configured to display, regardless of a screen shift in an application program for receiving a performance instruction, a specific display item configured to receive a stop operation for transmitting, to the image processing apparatus, a stop instruction to instruct the image processing apparatus to stop performing a job based on the performance instruction transmitted to the image processing apparatus, the image processing apparatus comprising:
at least one memory and at least one processor and/or at least one circuit which function as:
a performance unit configured to perform the job based on the performance instruction received from the information processing apparatus; and
a control unit configured to perform control to stop the job being performed by the performance unit based on a stop request transmitted from the information processing apparatus in response to an operation having been performed on the specific display item.

29. A method for controlling an information processing apparatus capable of communicating with an image processing apparatus, the method comprising:
performing control to transmit, to the image processing apparatus, a performance instruction to perform a job; and
performing control to display, on a specific screen configured to receive, from a user, an instruction operation relating to second processing performance of which is instructable by an application program for receiving the performance instruction, a specific display item configured to receive a stop operation for transmitting, to the image processing apparatus, a stop instruction to instruct the image processing apparatus to stop performing the job based on the performance instruction, the second processing being different from the job based on the performance instruction.

30. An information processing apparatus capable of communicating with an image processing apparatus, the information processing apparatus comprising
at least one memory and at least one processor and/or at least one circuit which function as:
a transmission control unit configured to perform control to transmit, to the image processing apparatus, a performance instruction to perform a job; and
a display control unit configured to perform control to display, on a specific screen configured to receive, from a user, an instruction operation relating to second processing performance of which is instructable by an application program for receiving the performance instruction, a specific display item configured to receive a stop operation for transmitting, to the image processing apparatus, a stop instruction to instruct the image processing apparatus to stop performing the job based on the performance instruction, the second processing being different from the job based on the performance instruction.

31. An image processing apparatus capable of communicating with an information processing apparatus configured to display, on a specific screen configured to receive, from a user, an instruction operation relating to second processing performance of which is instructable by an application program for receiving a performance instruction, a specific display item configured to receive a stop operation for transmitting, to the image processing apparatus, a stop instruction to instruct the image processing apparatus to stop performing a job based on the performance instruction transmitted to the image processing apparatus, the second processing being different from the job based on the performance instruction, the image processing apparatus comprising:
at least one memory and at least one processor and/or at least one circuit which function as:
a performance unit configured to perform the job based on the performance instruction received from the information processing apparatus; and
a control unit configured to perform control to stop the job being performed by the performance unit based on a stop request transmitted from the information processing apparatus in response to an operation having been performed on the specific display item.

32. A method for controlling an information processing apparatus capable of communicating with an image processing apparatus, the method comprising:
performing control to transmit, to the image processing apparatus, a performance instruction to perform a job; and
performing control to display, on a notification screen configured to display a notification relating to a plurality of pieces of application software, a specific display item configured to receive a stop operation for transmitting, to the image processing apparatus, a stop instruction to instruct the image processing apparatus to stop performing the job based on the performance instruction.

33. An information processing apparatus capable of communicating with an image processing apparatus, the information processing apparatus comprising:
at least one memory and at least one processor and/or at least one circuit which function as:
a transmission control unit configured to perform control to transmit, to the image processing apparatus, a performance instruction to perform a job; and
a display control unit configured to perform control to display, on a notification screen configured to display a notification relating to a plurality of pieces of application software, a specific display item configured to receive a stop operation for transmitting, to the image processing apparatus, a stop instruction to instruct the image processing apparatus to stop performing the job based on the performance instruction.

34. An image processing apparatus capable of communicating with an information processing apparatus configured to display, on a notification screen configured to display a notification relating to a plurality of pieces of application software, a specific display item configured to receive a stop operation for transmitting, to the image processing apparatus, a stop instruction to instruct the image processing apparatus to stop performing a job based on a performance instruction transmitted to the image processing apparatus, the image processing apparatus comprising:
at least one memory and at least one processor and/or at least one circuit which function as:
a performance unit configured to perform the job based on the performance instruction received from the information processing apparatus; and
a control unit configured to perform control to stop the job being performed by the performance unit based on a stop request transmitted from the information processing apparatus in response to an operation having been performed on the specific display item.
